(19) United States
(12) Patent Application Publication
(10) Pub. No.: US 2021/0092983 A1
(43) Pub. Date: Apr. 1, 2021

(54) MICROBIAL FOOD PRESERVATION SYSTEM AND METHOD

(71) Applicant: Jerry Tang, Palo Alto, CA (US)

(72) Inventor: Jerry Tang, Palo Alto, CA (US)

(21) Appl. No.: 17/106,044

(22) Filed: Nov. 27, 2020

(51) Int. Cl. A23L 3/3571; B65D 81/28; B65B 25/00

(52) U.S. Cl. CPC A23L 3/3571; A23V 2002/00; B65B 25/001; B65D 81/28

(57) ABSTRACT

A food preservation system and method comprise the use of at least one structure configured to be affixed to a food storage space, at least one microbe disposed on the at least one structure, and at least one container for sealing food in which the at least one structure and the at least one microbe are contained.

### TECHNICAL FIELD

The present disclosure relates generally to systems and methods for microbial food preservation. Disclosed are embodiments of the invention that relate to, among other things, food storage and preservation. In embodiments, the food storage and preservation invention provides for, among other things: improved duration of food storage, reduction in food waste, and environmental sustainability.

### BACKGROUND

Food spoilage may occur for a number of reasons, many of which relate to the food being exposed to oxygen and/or moisture (i.e., water). For instance, such food spoilage may be attributed to: (i) the growth of microorganisms such as mold, yeast, and bacteria; (ii) oxidizing enzymes that catalyze chemical reactions in food product breakdown and degradation, resulting in browning and foul odors; and/or (iii) oxidizing lipids attacking the fatty portions in food, resulting in foul odors and an unpleasant off flavor.

It has been known in the art to use refrigeration technology to try to reduce food spoilage. Home refrigerators are concentrated on “freezing” or “freeze preservation.” This focus is the same as for business-use refrigerators. However, there are drawbacks to this type of technology as it relates to food spoilage in particular. For example, when frozen food is defrosted, the quality of the food is deteriorated as compared with fresh food that is not frozen. In ordinary freezing, when food at a room temperature is placed into a space have its temperature set to −18° C., the temperature of the food is cooled to the same temperature as the space after a predetermined time passes. The food will freeze when the temperature is equal to, or less than, the freezing point of the food. When the food is placed in a low temperature environment, it is gradually cooled from the surface and thereafter the central portion of the food reaches a peripheral temperature. Since the temperature of the surface of the food is lowered first, a phenomenon arises due to the surface becoming frozen first. As ice crystals formed on the surface of the food are enlarged while utilizing the unfrozen water in the food, large needle-like crystals are created toward the central portion of the food. Since the large needle-like crystals break the intrinsic structure of the food (such as meat, fish, and the like), it is very difficult to restore the food to the same shape, state, and condition as it existed before being frozen.

There is known a quick-freezing technology, the effectiveness of which is often evaluated by a method of comparing the amounts of drips flowing out from meat and the like when they are defrosted. The flowing-out amount of the drips greatly depends on the positions where ice crystals are created and the size of the ice crystals when food is frozen. When the size of the ice crystals is large, food cells are broken and the flowing-out amount of the drips is increased during defrosting, all of which results in diminished food quality. In contrast, when the ice crystals are small in size, the shape of cells are kept and the flowing-out amount of the drips is reduced during defrosting, thereby resulting in the “flavor” of food being better preserved.

Quick-freezing is a means for suppressing creation of large ice crystals in food. Conventional technology for performing quick-freezing in a refrigerator includes a quick-freezing vessel, which has a metal plate on a bottom and a cold air duct that is disposed above the opening of the upper surface of the quick-freezing vessel in order to provide cold air for cooling food in the quick-freezing vessel, and where the quick-freezing vessel is installed in a quick-freezing chamber, such as is disclosed in Japanese Unexamined Patent Application Publication No. 2005-83687 (pages 16-17, FIGS. 2 and 3).

However, quick-freezing has several disadvantages. For example, although the size of ice crystals can be reduced by quick-freezing, small ice crystals may still form up to the central portion of the food. Food surfaces to which cold air is directly applied may be rapidly cooled and small ice crystals result. However, the temperature of the central portion of the food is not sufficiently reduced and the central portion remains susceptible to ice crystal formation. Large ice crystals or needle-like ice crystals are created, which require a large amount of energy to blow ultra-cold temperature air to achieve quick-freezing. Typically, a large compressor with high performance is required to make the ultra-cold temperature air, which is costly in terms of energy usage.

Supercooled freezing technology also exists whereby food is not frozen at a temperature equal to, or less than, the temperature of the freezing point of the food. Preserving food in the supercooled state is advantageous in that it avoids denatured protein and cell structure damage by virtue of the fact that food frozen through the supercooled state creates fine granular ice crystals instead of needle-shaped ice crystals, such as disclosed in Japanese Unexamined Patent Application Publication No. 2003-180314 (paragraph [0012]). In other aspects, supercooled freezing includes a rapid cooling process for cooling foods, such as, for example, vegetable, fruits, meat, fish, from a room temperature to the vicinity of the ice-freezing point relatively rapidly and subsequently performing a slow cooling at a rate of 0.01° C./h to 0.5° C./h up to the ice-freezing point or less, such as that disclosed in Japanese Unexamined Patent Application Publication No. H8-252082 (claim 1, paragraph [0015]). However, when the supercooled state continues for too long, the quality of food may be deteriorated by oxidation and the breeding of bacteria. Further, the food in the supercooled state is unstable and conventional supercooling is liable to be stopped before a lowest reach point temperature reaches to a deep (low) point in the supercooled state, and when the lowest reach point temperature is shallow (high) that ice nucleuses made during stopping the supercooled state are small, all of which compromise the freezing quality.

Another method employed in the art is utilization of food preservatives, such as heat treatment and chemical based methods, for inhibiting microbial growth in food products. During pasteurization for example, direct or indirect application of heat to the food is a commonly used method for pasteurizing food products. However, such heat can damage the food matrix, resulting in undesirable flavor and/or textural changes. In addition, nutritional breakdown can also occur.

An alternative to heat treatment is the use of chemical ingredients which have antimicrobial properties. Compounds such as potassium sorbate, propionates, or benzoates are often added to foods to protect against microbial spoilage. However, these compounds are only useful against certain classes of microorganisms, and in some cases, can adversely affect the flavor of the food product. These antimicrobial food preservatives are conventionally classified as phenolic antioxidants, e.g., tertiary butylhydroquinone (“TBHQ”), and have been investigated against Listeria monocytogenes in a model milk system (Payne et al., “The Antimicrobial Activity of Phenolic Compounds Against Listeria monocytogenes and Their Effectiveness in a Model Milk System,” J. Food Protection, 52, 151-153 (1989)). Propyl paraben was the only consistently active inhibitor observed throughout the reported testing.

It has been found that foods can also be protected from microbial action by a class of proteins known as bacteriocins (e.g., nisin, pediocin, and colicin). It is known that there may be synergistic effects from co-administration of lantibiotics (e.g., nisin) and a selected agent against gram-positive bacteria such as Listeria monocytogenes. The selected agent is identified as amino acids, aliphatic mono- and di-carboxylic acids, phenolic antioxidant antimicrobials, benzoic acid including salts and esters thereof, or food gums. A considerable number of possible phenolic antioxidant candidates (e.g., 1-7C aliphatic esters of parahydroxy benzoic acid, butylated hydroxy toluene (“BHT”), butylated hydroxyanisole (“BHA”), and TBHQ) were identified, including methyl paraben, which was the only phenolic antioxidant illustrated in combination with nisin. Given that nisin addition levels in finished foodstuffs is currently limited to 250 ppm in the United States (see 21 C.F.R. § 184.1538), it is desirable to reduce the amount of nisin needed for effecting microbial inhibition.

It is also known to use high pressure processing (“HPP”) as a method for preservation of foods. In such processing, high hydrostatic pressure without thermal treatment is applied to a food product to reduce its microbial load, as disclosed in U.S. Pat. No. 6,635,223. As a “non-thermal” technology, HPP does not cause heat-related changes to food quality. Sufficiently high hydrostatic pressure conditions may be used in HPP to permanently destabilize cytoplasmic cell membranes of food-borne microorganisms, i.e., reducing their survivability and activity, without causing damage to the food matrix.

However, HPP is not widely utilized because it often lacks commercial viability. There are high equipment and operating costs associated with attaining the very high pressures required to effect such cellular destabilization using HPP. Additionally, commercially viable processing times or pressures cannot always achieve the desired level of microbial inactivation due to a “tailing effect” with HPP. The initial application of high pressure to a food having a relatively high microbial load causes the microbial load to be significantly reduced, e.g., by a reduction factor greater than or equal to 106, within several minutes. However, after that initial substantial reduction in microbial load by HPP, the effectiveness of HPP diminishes greatly and considerably longer treatment times are necessary in order to effect continued microbial destruction (i.e., the “tailing effect”). Those skilled in the art have observed the tailing effect in the treatment of Listeria monocytogenes on vacuum-packaged frankfurters by application of HPP, as reported in Lucore, et al., “Inactivation of Listeria monocytogenes Scott A on Artificially-Contaminated Frankfurters by High-Pressure Processing,” J. Food Prot., 63, 662-664 (2000) and Tay et al., “Pressure Death and Tailing Behavior of Listeria monocytogenes Strains Having Different Barotolerances,” J. Food Prot., 66, 2057-2061 (2003).

Morgan et al., “Combination of hydrostatic pressure and lacticin 3147 causes increased killing of Staphylococcus and Listeria,” J. Appl. Microbio., 88, 414-420 (2000) reported on the use of HPP in combination with bacteriocin lacticin 3137 for enhancing food safety at lower hydrostatic pressure levels. Morgan discussed use of HPP in combination with bacteriocins such as nisin and pediocin for inhibition of food borne microorganisms.

However, Mackey et al., “Factors Affecting the Resistance of Listeria monocytogenes to High Hydrostatic Pressure,” Food Biotechn., 9, 1-11 (1995) reported that the resistance of Listeria monocytogenes to high hydrostatic pressure treatment is reduced when the microbial cells have been sensitized with butylated hydroxyanisole (“BHA”) at the time of pressure treatment. Butylated hydroxy toluene (“BHT”) was also found to be ineffective.

Gas packaging of foods for preservation is also well known as described in A. L. Brody, “Controlled/Modified Atmosphere/Vacuum Packaging of Foods,” Food & Nutrition Press, Trumbull, Conn. 01989, J. J. Jen, “Quality Factors of Fruits and Vegetables,” Chemistry and Technology (ACS Symposium Series No. 405), American Chemical Society, Washington, D.C., 1989, and N. A. Michael Eskin, “Biochemistry of Foods,” second ed., Academic Press, New York N.Y., 1990. Disclosed in these references are gas packaging methodologies that relate to use of carbon dioxide, nitrogen, and oxygen, alone or in mixtures. Generally, nitrogen is an inert or non-reactive gas and is used in these methodologies to displace oxygen in order to prevent oxidation or limit respiration. It is also evident that the balance of such gases in an atmosphere superimposed upon living systems may depress respiration and thus depress the resulting production or maintenance of chemical and/or other food quality parameters in basic and well-understood ways. It is also evident that oxidative and reactive gases will have destructive effects upon chemical and biological systems. Although literature has appeared describing the use of argon for packaging, this literature generally describes the gas to be completely inert and equivalent to nitrogen or the other noble gases in their non-reactivity.

In the medical area, the noble gases are described as being useful in the preservation of living organs, cells, and tissues, primarily due to the high solubility and penetrability of the gases. For example, prior comparisons have shown impacts on sperm motility and viability in nitrogen, argon, helium, and carbon dioxide, where thermal factors are most important.

Generally, carbon dioxide is used as a microbiocidal or microbiostatic agent, or as in the case of certain beverages, to provide an effervescent effect. Carbon dioxide is also often used as an inert gas. Generally, oxygen is used as such or as the active component in the inclusion of air in order to permit aerobic respiration or to prevent the development of anaerobic conditions which might permit the growth of pathogenic microorganisms.

For example, U.S. Pat. No. 4,454,723 describes a refrigerated trailer cooled by sprinkler water with release of nitrogen to prevent the respiration of produce. CH 573848 describes use of nitrogen in the preparation of coffee packages. U.S. Pat. No. 6,342,261 discloses use of a nitrogen atmosphere or liquid in the preservation of strawberries, bananas, malting barley, sunflower seeds, salmon, shrimp, and fish. This art was described as showing improved control of bacteria and changes in oxidative metabolism, that is, respiratory rates.

U.S. Pat. No. 4,515,266 discloses gas packaging applications, including modified atmosphere packaging high barrier films used in the packaging and a preservative atmosphere being introduced into the package, while simultaneously preventing air from getting into the package that would cause degradative oxidation of the food.

U.S. Pat. No. 4,522,835 shows that oxygen-containing gases, such as oxygen itself, carbon dioxide, and carbon monoxide, can be reactive in food systems and that by reducing the same it is possible to preserve color in poultry and fish. It is disclosed that this phenomenon is due to reducing oxygen content to produce myoglobin/hemoglobin versus the ordinary oxidized states of oxymyoglobin/hemoglobin, and then adding carbon monoxide to produce carboxymyoglobin/carboxyhemoglobin, and finally storing under carbon dioxide to maintain the improved color. U.S. Pat. No. 4,522,835 further discloses that storage under inert nitrogen is possible, as is further re-oxidation using oxygen.

EP 354337 claims the use of carbon dioxide as an antibacterial agent in the preservation of foods. SU 871363 describes the storage of plums in nitrogen, oxygen and carbon dioxide mixtures in three separate steps: first, 2-2.5 weeks at 0° C. in 78-82% nitrogen between 10-12% oxygen and 8-10% carbon dioxide; second, 2.5-3 weeks at −1° C. in 93-95% nitrogen between 3-5% oxygen and 2-4% carbon dioxide; and third, remainder of storage period at −2° C. in 90-92% nitrogen between 2.5-3.5% oxygen and 4.5-5.5% carbon dioxide.

Each of WO 9015546, CA 2019602, and AU 9059469 describes ethylene-induced maturation in food and the improved preservation of food in a process using two gas separators. First, unwanted gases such as ethylene, oxygen, carbon dioxide, and water vapor are removed, and second, the preservative (inert or respiratory mix) gas is supplied.

JP 2010077 describes the use of a mixed gas source to supply a gas-packaged product with a mixture of nitrogen to carbon dioxide to ethylene 60:30:1 in conjunction with argon. JP 3058778 describes storage and maturation of beverages in an argon containment. By regulating packaging density of argon, deterioration can be prevented and maturation can be promoted or delayed. JP 58101667 describes sealing of beverages under pressure using argon as the inert gas.

JP 62069947 discloses preserving shiitake mushrooms in maturation conditions in a container in a mixture of nitrogen, carbon dioxide, argon, and nitrous oxide.

JP 7319947 claims fruit juice preservation with noble gases. However, argon, helium, and nitrogen are described as inert gases. U.S. Pat. No. 4,054,672 describes the defrosting of frozen foods under a pressure of 2-5 atmospheres, preferably under carbon dioxide or nitrogen or helium or argon, all being inert, non-reactive and non-oxidizing.

JP 89192663 claims preservation of alcoholic beverages with argon, specifically sake and wine in containers, where argon is considered as a superior inert gas agent due to its higher solubility than nitrogen.

U.S. Pat. No. 3,096,181 describes a food processing method and apparatus used in gas packaging of tomato juice or liquid food products or vegetable concentrates, where any inert gas from the group of nitrogen, argon, krypton, helium, or mixtures thereof, are equally inert and useful at or above ambient pressure, after steam sterilization.

U.S. Pat. No. 3,715,860 describes a method of gas packaging wherein inert fluid passes through an impermeable container and is used to remove oxygen and prevent spoilage. U.S. Pat. No. 4,205,132 describes the storage of lyophilized bacteria in complete absence of oxygen, preferably using argon. U.S. Pat. No. 4,229,544 describes the storage of dormant living microorganisms by gas packaging in nitrogen, argon, or helium, where all are equivalent.

In past experiments, Pseudomonas proteases were tested under carbon monoxide, carbon dioxide, and nitrogen. Air and argon were used as mixers and control for the testing. Of those, only carbon dioxide was found to have conflicting effects depending upon which protease was measured. It was also determined that argon was specifically found not to have an effect on these enzymes.

The effects of carbon monoxide, carbon dioxide and nitrogen were investigated with respect to bacterial growth on meat under gas packaging. Argon was used as the inert control. It was found from these experiments that argon and nitrogen were equivalent in inhibition of anaerobes, and acted as inerting agents in inhibiting aerobes. Specifically, 4 strict aerobes, 3 anaerobes, and 12 facultative anaerobes isolated from meat were grown under carbon dioxide, argon, nitrogen, carbon monoxide, where argon was “inert” containing 10-70% nitrogen, carbon dioxide or carbon monoxide.

Thus, it is evident from the above that argon is perceived of, and has been clearly described in patent and literature citations, to be an inert and non-reactive gas that is capable of affecting biological systems (such as food products, medical tissues, chemical reactions, enzymes, and food storage parameters) only by means of displacing more active gases, such as oxygen. Thus, argon has been conventionally considered to be the equivalent of nitrogen as an inert and non-reactive gas, and is presently differentiated for use in the food industry solely based upon such commercial factors as cost, availability, and purity.

For example, JP 52105232 describe the use of a gas mixture containing argon for preserving roasted chestnuts by retarding the growth of anaerobic molds, and extends this preservation to include rice cakes, bread, cakes in 80-20:30-70 argon:carbon dioxide, describing that this prevents the growth of molds and anaerobic microorganisms. However, the data provided are self-conflicting, holding that neither high levels nor low levels of argon have effects, but that intermediate levels do, in a simple experiment in which significant data is not presented, no tests or controls for oxygen levels were conducted, and no demonstration of the described anaerobicity of the molds tested was made. In fact, the data does not show an improvement for argon, and may be interpreted as simply proposing the substitution of argon for nitrogen as an inert and non-reactive gas.

Helium and the high pressure application of various noble gases have been described as affecting the growth of bacteria, protozoa, mammalian cells, and bacterial spore germination. However, such descriptions provide inconclusive results and are difficult to interpret.

A two-step treatment process for preservation of fresh fruits and vegetables is disclosed in EP 0422995. Nitrous oxide (10-100%) in admixture with oxygen and/or carbon dioxide is applied to vegetables for a time period in a first phase of treatment, followed by a separate second phase application of a gas mixture which contains nitrous oxide (10-99%) admixed with oxygen or carbon dioxide or nitrogen, which by action of the nitrous oxide then confers preservation. It is clearly described that nitrogen or argon are equally inert and non-reactive gases which may be freely used to complement in bulk any given gas mixture without effect.

U.S. Pat. No. 5,128,160, EP 0422995, AU 9063782, CA 2026847, FR 2652719, BR 9004977, JP 03206873, PT 95514 each describes a two-step treatment for preserving fresh vegetables by exposure at refrigeration temperature to an atmosphere of nitrous oxide and/or argon (other noble gases are specifically claimed to be inert) and optimally oxygen. Mixtures used variously include high titers of nitrous oxide, oxygen, carbon dioxide, or nitrogen.

The essence of each of these disclosures pertains to a two-step treatment process, not simple gas packaging, in which applied nitrous oxide or argon directly interferes with the production of ethylene by the fruit (tomatoes were tested). Argon is claimed to have specific utility in this regard; however, it is obvious from the data presented that the only effect of argon is to displace oxygen from the tissues of the fruit and thereby to limit respiration and thus ethylene production. The essential data presented in the figure purport to show a difference in ethylene production of air, nitrogen, argon, and nitrous oxide which is precisely identical to their differences in solubility in the fruit (data given in EP 0422995 and below). In fact, this has been proven by U.S. Pat. No. 6,342,261 which duplicated the aforementioned experiment with adequate controls for solubility and included other gases. As provided for in the data in FIG. 1 of U.S. Pat. No. 6,342,261, it was found that depression of ethylene is completely explained by oxygen displacement. It may be appreciated that argon in food treatment serves as a non-reactive gas useful to displace air.

Such systems involving the use of inert gases have a number of disadvantages. One such disadvantage is that their utility is often limited to a single use, which will cease upon exposure to air or in the event of leakage of the gas itself or infiltration of ambient air into such packaging.

In other technologies, a vacuum reduction and elimination of spoliation gases from a food have been employed. A low vacuum may remove some of the undesirable residual gases, such as oxygen. It has been found that packaging at the highest vacuum allowable for each particular food product may result in greater storage lifetime and preservation of flavor. There exist various appliances and methods with the purpose of vacuum packaging and sealing plastic bags and containers to protect perishables, such as food products, against oxidation. Those skilled in the art would be aware that these vacuum and sealing appliances use a heat-sealing element to form a seal at the open end of the container being sealed. Typically, the container may be evacuated of excess moisture and air prior to heat sealing in order to minimize the spoiling effects of oxygen on food. One drawback to this technique is its single use for food preservation. Another drawback is that excess food and moisture that was not fully evacuated in proximity to the machine seal may inhibit sealing and lead to poor seal quality. Furthermore, using two heat sealing elements to form two seals adjacent to one another in proximity to the open end of the container still suffer from excess food and moisture not being evacuated in the seal area and inhibiting proper sealing.

Despite the above benefits of vacuum packaging, it has limited utility for repeat use and/or access to the food. Additionally, incomplete vacuum packaging or leakage are prominent, and the viability of vacuum packaging ceases once there is exposure to air.

There is an increased need for environmental sustainability in food preservation techniques given the significant growth of the human population, which in turn has led to an increased demand for food and energy. Food insecurity remains a huge issue despite rapid developments across the globe. According to the United States Department of Agriculture (“USDA”), 11.1% of all families in the U.S. experienced some level of food insecurity in 2018.

Food waste is an unfortunate reality that contributes to the above. According to the U.S. Food and Drug Administration (“FDA”), between 30-40 percent of supplied foods are wasted. Furthermore, 31% of the total food loss occurs at the retail and consumer level. Food waste is detrimental for the environment in many respects, including: (a) an increased carbon footprint; (b) an unnecessarily high (excess) food production that wastes resources and energy; and (c) the environmental damage of treating wasted foods. Additionally, it has been reported that food waste is the largest source of material placed into landfills in the U.S. Landfills are very detrimental to the environment, taking up precious land resources and contributing pollution to the local ecosystem, which includes the leakage of toxins, pollutants, and runoff into local soil and rivers. These negative impacts in turn lead to habitat destruction and further damage to ecosystems. It should also be noted that landfills produce methane, which is a potent greenhouse gas.

It has been shown that food suppliers and producers engage in excess food production. This excess food production leads to a larger carbon footprint on a global scale, for many reasons, some of which are discussed above. It is exemplary that food waste has been determined to account for about 17% of total greenhouse gas production in the United States.

Household accounts for most of the food waste in the U.S., of which two thirds is due to food spoilage. Food production accounts for 15.7% of the total energy budget in the U.S., and additionally 50% of the land and 80% of the water consumed. Food production accounts for one quarter of the world's greenhouse gas emissions, due to processes including land use, animal feed, transportation, processing, etc. (Gunders, Dana. “Wasted: How America is Losing Up to 40 Percent of Its Food from Farm to Fork to Landfill.” Natural Resources Defense Council, 2017). Therefore, reducing the amount of total food production will in turn lead to a reduction in the overall environmental impact of food production.

Traditional composting of food waste also has many negative environmental impacts: methane emission (86 times more powerful than CO₂), land consumption, freshwater consumption, ecosystem contamination, habitat destruction etc. Additionally, composting creates humanitarian issues regarding their placement, since they often more heavily impact those who live in economically disadvantaged locations and communities.

It is contemplated that a reduction in food waste will have a direct correlation with a decrease in the overall amount of food insecurity, at least in part due to more food becoming available for distribution to people in need (e.g., individuals living in poverty). Such food may otherwise be discarded and end up in a landfill, if it were not being distributed.

In an unrelated field of endeavor, Santoro and associates used microbial solutions for electrolysis of food wastes. See Santoro et al., “Microbial fuel cells: From fundamentals to applications. A review,” J. Power Sources, 356 (2017), 225-244. However, there is no proof that microbial technology has any practical application in food storage and/or to fix atmospheric composition in food packaging. As Santoro and associates report, use of microbial fuel cells itself is a nascent technology and not fully developed.

Accordingly, there is a need to resolve the deficiencies that exist in the contemporary food preservation technologies of today. In particular, there is a present need to substantially limit food waste, which may be facilitated by enhancing food stability as well as increasing the ability to repeatedly preserve and re-preserve food products. The foregoing discussion is provided to facilitate a better understanding of the present disclosure and technical field to which it pertains, and is not to be regarded as any admission of prior art.

### SUMMARY OF THE INVENTION

As opposed to the contemporary art in the field, the present invention makes use of the oxidation reduction principles in microbial metabolism to fix the air composition in a food storage space by decreasing water and/or oxygen concentration in the storage space. To achieve this end, the present invention incorporates a microbe structure located separate and apart from the food meant to be preserved. In some embodiments, the microbe structure may be set apart from the food by a membrane.

An exemplary microbe may be used to remove oxygen from the air through microbial metabolism. The oxidation reaction process in microbial metabolism utilizes oxygen as the electron acceptor in cellular respiration. Preferable microbes include obligate aerobes and facultative anaerobes. Even more preferably, autotrophic microbes may be used.

In an exemplary process, at least one microbe and a food are stored in a containment space whereupon the microbe is exposed to the supplied air in the storage space. By using the oxygen in the storage space as its electron acceptor, the microbe reduces the available oxygen that would otherwise degrade the food.

In another exemplary process, the microbes used in the containment space may be used to reduce water instead of oxygen. Accordingly, a preferable microbe would be a chemolithotroph. Like the previous exemplary process, the microbe would reduce the water concentration in the space to avoid degradation of the food.

In yet another exemplary process, microbes may be used to remove rust from a storage space or container (e.g., a food packaging). In this exemplary process, an exemplary microbe would remove oxygen to reduce and/or eliminate the conversion of iron to iron(III) oxide. In this exemplary process, the microbes would be located on a biofilm on the iron surface. Thus, the microbe may consume the free oxygen before said oxygen is used to convert the iron to iron(III), e.g., rust formation. In a preferred aspect of this exemplary process, the microbe may be a chemolithotroph, such as, for example, the Halomonas titanicae.

While embodiments describe one or more types of microbes, it is contemplated that a community or combination of microbes may be utilized to collectively reduce unwanted food-degrading gases in a storage container setting.

The above and other aspects, features, and advantages of the present disclosure will become apparent from the following description read in conjunction with the accompanying drawings, in which like reference numerals designate the same elements.

### BRIEF DESCRIPTION OF THE DRAWINGS

A further understanding of the present disclosure can be obtained by reference to embodiments set forth in the illustrations of the accompanying figures. The illustrated embodiments are merely exemplary of methods, structures, and compositions for carrying out the present disclosure. Both the organization and method of the disclosure, in general, together with further objectives and advantages thereof, may be more easily understood by reference to the figures and the following detailed description section. The figures are not intended to limit the scope of this disclosure, which is set forth with particularity in the claims as appended or as subsequently amended, but merely to clarify and exemplify the disclosure.

For a more complete understanding of the present disclosure, reference is now made to the following figures in which:

FIG. 1 illustrates a first exemplary embodiment of the invention.

FIG. 2 illustrates a diagrammatic method of operation of an embodiment of the invention using cross-section x-x in FIG. 1.

FIG. 3 illustrates a second exemplary embodiment of the invention.

FIG. 4 illustrates an alternative exemplary embodiment of the invention.

In the drawings, like characters of reference indicate corresponding parts in the different figures. The drawing figures, elements and other depictions should be understood as being interchangeable and may be combined in any like manner in accordance with the disclosures and objectives recited herein.

### DETAILED DESCRIPTION

Reference will now be made in detail to embodiments of the invention that are illustrated in the accompanying figures. Wherever possible, the same or similar characters of reference (which may be in numerical or alphanumerical format) are used in the figures and the written description to refer to the same or like parts or steps. The figures are in simplified form and are not to precise scale. The figures are non-limiting examples of the disclosed embodiments of the present disclosure and corresponding parts or steps in the different figures may be interchanged and interrelated to the extent such interrelationship is described or inherent from the disclosures contained herein. The specific functional and structural details disclosed herein are merely representative, yet in that regard, they are deemed to afford the best embodiment for purposes of disclosure and to provide a basis for the claims herein, which define the scope of the present disclosure.

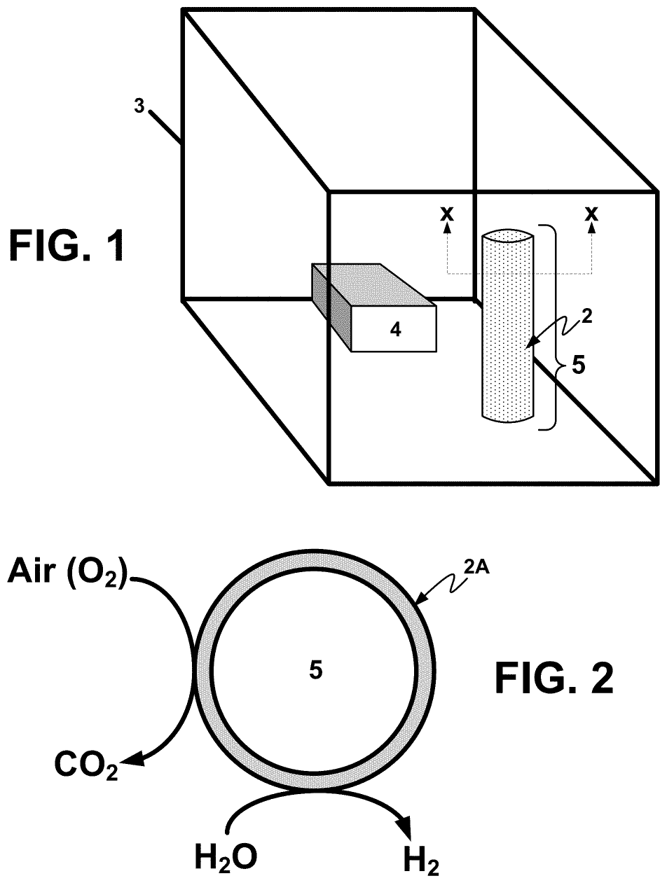

In an exemplary embodiment of the invention as illustratively provided for in FIG. 1, at least one species of microbe 2 may be placed onto an object 5 and locating the same in a space 3 adjacent a food product 4. Preferably, the microbe is an aerobe, such as, for example, Nocardia sp., Pseudomonas aeruginosa, Mycobacterium tuberculosis, and Bacillus sp., Staphylococcus sp., Streptococcus sp., Enterobacteriaceae sp., Bordatella sp., Campylobacter, Helicobacter, and Borrelia burgdorferi. Alternatively, the microbes may be a combination of aerobes and facultative anaerobes. According to the aforementioned illustrative embodiment, a majority of the microbes 2 located on support 5 would have the ability to consume oxygen and/or other gases within space 3 known in the art to degrade food.

An exemplary function of a disclosed system may be illustratively provided for in FIG. 2. An exemplary support 5 may be covered with a biofilm 2A, which may be comprised of a plurality of microbes 2. Such a biofilm 2A when disposed on support 5 may cause reductions in oxygen-containing specie such as air or water through microbe 2 metabolism of the same. As a result, the biofilm-covered support 5 may reduce the food degrading effects of oxygen in a storage space by removing the activated oxygen specie through metabolism. Removal of these active oxygen specie also provide additional downstream benefits of reducing propensity for iron supports to rust during conversion of iron to iron oxide. While FIG. 2 may show a cross-section of an exemplary support structure 5, any kind and variety of support structures may have the same or similar cross-sections with similar chemical functionalities.

Adhesion of a microbe 2 or combination of microbes 2 to a support 5 (or 6 as described elsewhere) is known in the art, as provided for in U.S. Pat. Nos. 5,409,838, 5,089,413, and 4,565,783, which are incorporated herein by reference in their entireties. With respect to supports 5 that are spherical, cylindrical, or otherwise have curved surfaces, a microbe 2 may be adhered by spraying or brushing the adhering powders and gels to the surface of the support 5. With respect to supports 5 that have flat or recessed surfaces, a particular microbe 2 growth culture may be placed onto such surfaces. A combination of either coating methods may be employed for purposes of the present invention. In an alternative embodiment, selective adhesion and removal of microbes 2 from a support 5 may be desirable, for which there exist known technologies, such as, for example, the types disclosed in U.S. Pat. No. 9,920,353, which is incorporated herein by reference in its entirety.

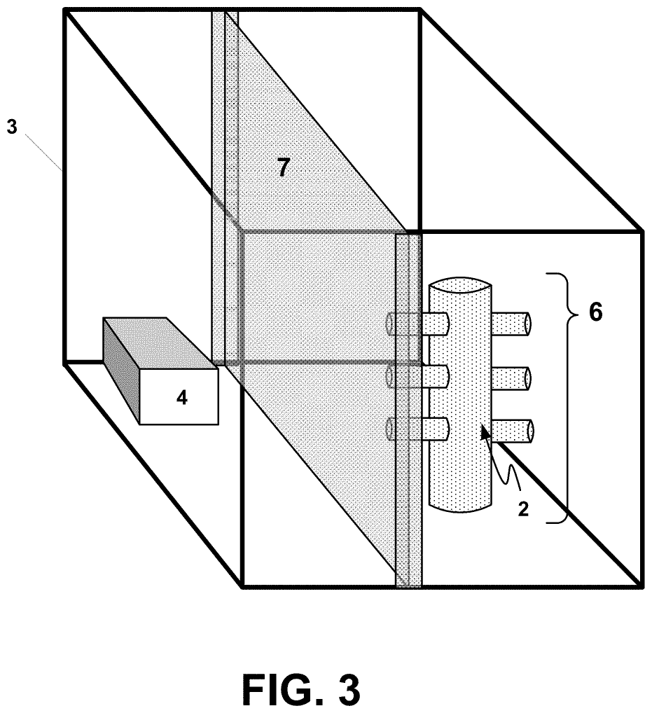

Microbe 2 may live off of a food source (not shown) disposed on support 5/6, such as glucose or acetate, or through the byproducts of metabolism of adjacent and co-existing microbes. Alternatively, microbe 2 may be a type of autotroph that can use atmospheric CO₂ as its food source (e.g., carbon), either disposed on support 5/6 or as byproducts of neighboring microbe metabolism. In a preferred embodiment, microbe 2 is adequately separated from food 4 so as not to cause food 4 to be the source of food for microbe 2. As illustratively provided for in FIG. 3, a permeable membrane 7 may exist between food product 4 and microbe 2 located on a support 6. Configurations and design of appropriate membranes for separating microbes 2 from food 4 are known to those skilled in the art.

As further illustrated in FIG. 3, an exemplary support 6 may have increased surface area for reception of oxygen from air and/or water located in the containment 3. As such, supports 6 that take the form of brushes, finned structures, and/or branched or multi-grooved structures may increase contact between a resulting biofilm 2A and the containment 3 environment. Furthermore, strategic placement of microbes about a support 6 may increase the synergistic capabilities of the microbes 2 when used in combination.

In other embodiments, some form of iron may be part of the storage container 3, either flat, long, circular shapes to maximize surface area, in order to maximize oxidation reactions and/or microbe placement. Instead of using iron powders as was done in the prior art, the system herein described allows for the existence of a biofilm on the iron scaffolding structure. When the iron undergoes rusting (reacting with oxygen in the air), the microbes on the biofilm may be of the type that consume iron, e.g., chemolithotrophs, Halomonas titanicae, etc.

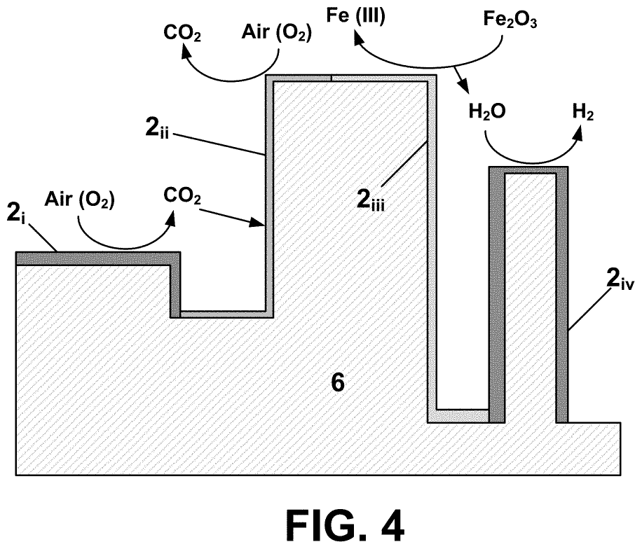

In an exemplary embodiment, an exemplary food preservation system may utilize different microbes 2 with different rates and chemical instigation of metabolism. For example, as illustratively provided for in FIG. 4, a plurality of microbes (2ᵢ, 2ᵢᵢ, 2ᵢᵢᵢ, and 2ᵢᵥ) may have differing rates and chemical metabolisms and/or may work in combination to simultaneously reduce the propensity for the container environment to degrade food while also increasing the longevity of the microbes. As may be envisioned from the illustrative disclosures of FIG. 4, a suitably configured support 6 may carry a plurality of microbes either individually or in biofilm sections on its various surfaces. A first microbe/biofilm section 2ᵢ may be utilized to remove oxygen from air within the container 3 surrounding support 6. The resultant carbon dioxide from metabolism of microbes in section 2ᵢ may be used as a source of food for microbes in biofilm section 2ᵢᵢ, which may have the same propensity to remove oxygen (or other food degradative elements) from container 3. Microbes in biofilm section 2ᵢᵢᵢ may be used to remove rust (iron (III) oxide) with a resulting by-product of water, which, when metabolized by proximal biofilm section containing microbe 2ᵢᵥ, is further metabolized so as to remove the oxygen therefrom. As the diagrammatic representation illustratively disclosed by FIG. 4 may show, the multivarious and strategic placement of microbes about a structure may advantageously maximize the metabolism of the separate microbes so as to generate synergies and efficiencies, e.g., adjacent placement of microbes that consume oxygen, microbes that consume water, microbes that consume iron (III) oxide, and combinations of the same.

The exemplary system disclosed may be used to extend food storage by changing the air composition through microbial metabolism. As an environmental modification means, microbial oxidation does not require additional energy input (such as electricity) and may be self-functional and self-sustaining. However, it is contemplated that the disclosed microbial mechanisms may be used alone or in combination with previously-described methods to preserve foods in a storage environment, e.g., freezing, vacuum sealing, subjecting the food to inert gases such as Argon.

It is well known that microbes consume oxygen at levels of micromoles of oxygen (O₂) per colony-forming unit (“CFU”) per day depending on the microbe's aerobic capacities, such as, for example between 2×10⁻⁷ and 1×10⁻⁶ μmol O₂/CFU/day for facultative anaerobic bacteria (e.g., E. coli K-12, S. oneidensis MR-1, and M. aquaeolei VT8). Other studies showed that oxygen uptake rate (“OUR”) for L. gelidum subsp. Gelidum (an aerobe) could reach nearly 5.5 mg O₂/liter for 6.0×10⁷ CFU/ml. It is known that B. thermosphacta can consume up to 0.748 pg of O₂ per hour per cell, L. gelidum subsp. Gelidum 0.32 pg of O₂ per hour per cell, and C. divergens can consume up to 0.19 pg of O₂ per hour per cell. Others have reported oxygen consumption (QO₂) for bacteria, such as Escherichia coli, as 20 mmol O₂/gram dry weight of cell (“GDW”)/hour. Other oxygen uptake rates and figures are also provided for in Greig and Hoogerheide, “The Correlation of Bacterial Growth with Oxygen Consumption,” J Bacteriol. 1941 May; 41(5): 549-556, which is incorporated by reference in its entirety. As provided in Greig and Hoogerheide, the following bacterium have the corresponding oxygen uptakes: (i) Escherichia coli in 1% bactophene, 1% lactate, phosphate-buffer M/10, pH 7.0. 30° C.-24 mm³ O₂/hour/10⁸ bacteria, (ii) Willia anomala 4205 Fleishmanns, 1% yeast extract, 1% glucose, 30° C.-308 mm³ O₂/hour/10⁸ bacteria, (iii) Proteus vulgaris in 1% bactophene, 1% lactate, 37° C.-30 mm³O₂/hour/10⁸ bacteria.

With increase in colony growth (CFU and/or GDW), one can expect a corresponding increase in total oxygen consumption for the space (e.g., the preservation container). To increase the rate of oxygen removal from a storage space, one may utilize the various approaches discussed previously, such as vacuum removal of air from the storage space in combination with the provision of a corresponding mass of bacteria. Accordingly, the combination of microbe usage and known vacuuming techniques creates synergies not otherwise provided for in the contemporary art.

Many further variations and modifications may suggest themselves to those skilled in the art upon making reference to above disclosure and foregoing interrelated and interchangeable illustrative embodiments, which are given by way of example only, and are not intended to limit the scope and spirit of the interrelated embodiments of the invention described herein. Further, it will be understood by those skilled in the art that various changes in form and details may be made without departing from the spirit and scope of the present disclosure as defined by the appended claims and their equivalents. In other words, the present disclosure is not limited to the various exemplary embodiments disclosed herein, but rather these embodiments are intended to serve as illustrative examples to facilitate a more easy and complete understanding of the invention and present disclosure.

1. A food preservation system, comprising:
at least one structure configured to be affixed to a food storage space;
at least one microbe disposed on the at least one structure, wherein the at least one microbe is one of an aerobic, anaerobic, or facultative type microbe; and
at least one container for sealing food in which the at least one structure and the at least one microbe are contained.

2. The food preservation system of claim 1, wherein the at least one microbe is selected from the group consisting of Nocardia sp., Pseudomonas aeruginosa, Mycobacterium tuberculosis, and Bacillus sp., Staphylococcus sp., Streptococcus sp., Enterobacteriaceae sp., Bordatella sp., Campylobacter, Helicobacter, and Borrelia burgdorferi.

3. The food preservation system of claim 1, wherein the structure is selected from the group consisting of rods, brushes, plates, and spheres.

4. The food preservation system of claim 1, further comprising a plurality of microbes of which two are different types of microbes.

5. The food preservation system of claim 4, wherein at least one of the plurality of microbes is selected from the group consisting of Nocardia sp., Pseudomonas aeruginosa, Mycobacterium tuberculosis, and Bacillus sp., Staphylococcus sp., Streptococcus sp., Enterobacteriaceae sp., Bordatella sp., Campylobacter, Helicobacter, and Borrelia burgdorferi.

6. The food preservation system of claim 5, wherein the structure is selected from the group consisting of rods, brushes, plates, and spheres.

7. The food preservation system of claim 1, wherein the container has substantially no oxygen therein while also containing a food product.

8. The food preservation system of claim 1, wherein the container has substantially no water therein while also containing a food product.

9. The food preservation system of claim 1, wherein the container has substantially no rust therein while also containing a food product.

10. The food preservation system of claim 1, wherein the container has substantially no oxygen and substantially no water therein while also containing a food product.

11. A food preservation method, comprising the steps of:
containing a food product in a container;
exposing at least one microbe disposed on a structure to the atmosphere within the container; and
reducing one of oxygen, water, or rust in the container via the at least one microbe.

12. The food preservation method of claim 11, wherein the at least one microbe is selected from the group consisting of Nocardia sp., Pseudomonas aeruginosa, Mycobacterium tuberculosis, and Bacillus sp., Staphylococcus sp., Streptococcus sp., Enterobacteriaceae sp., Bordatella sp., Campylobacter, Helicobacter, and Borrelia burgdorferi.

13. The food preservation method of claim 11, wherein the structure is selected from the group consisting of rods, brushes, plates, and spheres.

14. The food preservation method of claim 11, further comprising a plurality of microbes of which two are different types of microbes.

15. The food preservation method of claim 14, wherein at least one of the plurality of microbes is selected from the group consisting of Nocardia sp., Pseudomonas aeruginosa, Mycobacterium tuberculosis, and Bacillus sp., Staphylococcus sp., Streptococcus sp., Enterobacteriaceae sp., Bordatella sp., Campylobacter, Helicobacter, and Borrelia burgdorferi.

16. The food preservation method of claim 15, wherein the structure is selected from the group consisting of rods, brushes, plates, and spheres.

17. The food preservation method of claim 11, further comprising the step of removing substantially all oxygen from within the container.

18. The food preservation method of claim 11, further comprising the step of removing substantially all water from within the container.

19. The food preservation method of claim 11, further comprising the step of removing substantially all rust from within the container.

20. The food preservation method of claim 11, further comprising the step of removing substantially all oxygen and water from within the container.
